(19) United States
(12) Patent Application Publication
(10) Pub. No.: US 2007/0254086 A1
(43) Pub. Date: Nov. 1, 2007

(54) Process for preparing high-purity xanthohumol-containing powder and use thereof

(75) Inventors: Alois Faltermeier, Wolnzach (DE); Sabine Massinger, Mainburg (DE); Josef Schulmeyr, Wolnzach (DE)

Correspondence Address: BROWDY AND NEIMARK, P.L.L.C.;624 NINTH STREET, NW, SUITE 300, WASHINGTON, DC, 20001-5303, US

(73) Assignee: NATECO2 GmbH & Co. KG, Wolzzach (DE)

(21) Appl. No.: 11/790,365

(22) Filed: Apr. 25, 2007

(30) Foreign Application Priority Data
Apr. 28, 2006 (DE) DE102006018 988.4

(51) Int. Cl. C12C 3/00

(52) U.S. Cl. 426/600

(57) ABSTRACT

In a process for preparing a xanthohumol-enriched hop extract, a concentrate having contents of up to 90% xanthohumol is obtained from a xanthohumol-containing hop raw material by dissolving the xanthohumol in lye and subsequent precipitation with acid.

### BACKGROUND OF THE INVENTION

1. Field of the Invention

The invention relates to a process for preparing a high-purity (60-90%) xanthohumol-containing product comprising the process step of preparing a xanthohumol-enriched hop extract by extracting a xanthohumol-containing hop raw material using highly compressed CO₂ as a solvent at pressures above 500 bar and at temperatures above 60° C.

2. Background Art

With regard to the background of the invention, the nutrition physiological principles of the invention will first of all be briefly described: according to these, hops are an indispensable raw material for the preparation of beer. In the dried form, it contains three basic groups of active ingredient. The hop resins lend the beer its characteristic bitterness. Hop oil, with its diverse aromatic components, imparts a typical aroma to the beer. The hop tannins consist of numerous polyphenols such as, for example, flavanols, proanthocyanidines, flavanoids of kaempferol and quercetin, benzoic acids and cinnamic acids. However, the evaluation thereof for the quality of beer is not uniform.

Most polyphenols of hops are readily soluble in hot water. They have an antioxidative effect and contribute to the taste. However, because they form clouding complexes with proteins in the finished beer during storage thereof, opinions vary as to their value. There are accordingly a large number of breweries that deliberately refrain from adding hop polyphenols in order to improve the storage quality of their beers and to reduce their susceptibility to clouding.

Hop products without tannin are obtained by way of the extraction of hops with solvents. Liquid and especially supercritical CO₂, which dissolves all bitter and aromatic substances but no polyphenols, has now become established in this regard worldwide. Extracts prepared with ethanol are less important.

Hop contains a highly specific polyphenol, namely xanthohumol, a flavonoid from the subgroup of the chalcones (sometimes also referred to as flavonols). Trials carried out in recent years across the globe have revealed that xanthohumol has highly beneficial anticancerogenic properties. The research work has now been extended to living cells. It is hoped that xanthohumol will in the future be used as a chemo-cancer-preventive substance. The preparation of a xanthohumol concentrate is accordingly a highly beneficial aim.

The solubility of xanthohumol is unusual for a polyphenol. It is so non-polar that it is hardly soluble in hot water but readily soluble in alcohol or alcohol/water mixes. On the other hand, non-polar solvents, such as hexane, cannot dissolve xanthohumol. Dried hops contains an amount of xanthohumol ranging from 0.2 to 1.0% by weight, depending on the type.

During the preparation of beer, xanthohumol is converted into isoxanthohumol. Isoxanthohumol has far fewer anticancerogenic properties. In addition, the bulk of the xanthohumol and also of the isoxanthohumol is separated, during the preparation of beer, by yeast, sediment and filtration. Conventional commercial beer is therefore not a particularly suitable source for utilising the cancer-inhibiting potential of xanthohumol. Desirable, in any case, is the preparation of a xanthohumol-enriched extract that can be added, for example, to finished beer or other foods or used per se as a chemopreventive preparation.

The prior art now contains a plurality of proposed solutions to this problem. DE 199 39 350 A1 describes a process for the preparation of a xanthohumol-enriched hop extract, wherein combinations of water and ethanol are used preferably in two extraction steps. Contents of 5-15% by weight xanthohumol are specified. However, in addition to xanthohumol, other hop tannins having the known tendencies to clouding are dissolved.

DE 102 40 065 A1 describes how all bitter and aromatic substances soluble with supercritical CO₂ are withdrawn from a conventional commercial xanthohumol-containing hop extract obtained with ethanol after the addition of a solid excipient. What is left after this purification step is a mixture of excipient, various resins insoluble in CO₂ and xanthohumol which however, at approximately 2% by weight, is only mildly enriched compared to hops. In a complex process, a concentrate is then obtained in a plurality of stages using a mix of organic/aqueous solvents. Contents of up to 85% by weight are said to be achieved.

EP 1 424 385 B1 discloses a process for preparing a xanthohumol-enriched hop extract, wherein a much higher degree of enrichment with xanthohumol is achieved than in the two foregoing documents. A xanthohumol-enriched hop extract is accordingly prepared by extraction of a xanthohumol-containing hop raw material using highly compressed CO₂ as the solvent at pressures above 500 bar and at temperatures above 60° C. According to the preamble of claim 1, the present process according to the invention is also based on a preparation step of this type. Starting herefrom, the object of the invention is to specify a process for preparing a xanthohumol-containing product, allowing even higher concentration rates, based on the xanthohumol, to be achieved without having to use organic solvents or multistage extraction processes.

### SUMMARY OF THE INVENTION

The basic manner in which this object is achieved by the invention consists in the fact that the xanthohumol-containing powder obtained by preparing a xanthohumol-enriched hop extract by extracting a xanthohumol-containing hop raw material using highly compressed CO₂ as a solvent at pressures above 500 bar and at temperatures above 60° C., is further concentrated by following method steps:
suspending the xanthohumol-enriched hop extract in an alkaline solution for separation between by-products and xanthohumol, the xanthohumol preferentially being dissolved,
separating the undissolved by-products,
neutralisating and precipitating the dissolved xanthohumol with acid,
separating the precipitated xanthohumol concentrate from the acid, and
drying the separated concentrate.

The above-mentioned aim is achieved in that the by-products such as, for example, chlorophyll are separated in an aqueous solution by adjusting the pH. There is thus achieved in an aqueous solution a xanthohumol content of up to 90% using a simple process dispensing entirely with organic solvents.

The crude extract is obtained from pelleted hops. For this purpose, the aromatic and bitter substances are extracted from the hops at conventional supercritical conditions of approximately 200-300 bar and 40-60° C. The residue is subjected to a second CO₂ extraction between, for example, 600 and 1,000 bar and 70-90° C. A hop extract having a xanthohumol content of from 10 to 40% by weight is thus obtained. Well-chosen separating conditions allow this extract to be removed from the separator in dry form. The hop extract thus obtained has a high xanthohumol content and additionally contains chlorophyll and moderately bitter hop resin components. It contains no disruptive clouding polyphenols such as flavanols and proanthocyanidines. It also contains no protein, no carbohydrates and, in particular, no undesirable salts such as, for example, nitrate. It requires no further working-up nor drying and contains no hop-extraneous additives. This enriched powder can be used in this form for specific applications but also serves as a starting basis for the described further enrichment.

The invention further relates to the use of a highly xanthohumol-enriched hop extract prepared as described hereinbefore as an admixture to solid, paste-like or liquid foods. An admixture in dry, free-flowing form is particularly suitable as an addition to solid foods. However, the dry free-flowing form of the hop extract can also readily be dissolved in a suitable organic solvent. The solvent used is preferably ethanol. It is equally possible to emulsify the powder in a known manner. Both preparations can then be added to a drink. This can be carried out, for example, in the form of continuous addition using a pumping or conveying process.

Further features, details and advantages of the invention will become clear from the following description of a plurality of embodiments. Production can be carried out in individual steps (laboratory scale) but preferably in a continuous, automated sequence.

### DESCRIPTION OF THE PREFERRED EMBODIMENTS

### Embodiment 1 (Laboratory Scale)

A markedly dark green powder having a xanthohumol content of 24.3% by weight was used for the test. 50 g of powder were suspended with 80 ml ethanol (the powder is “steeped” and is thus distributed, in the following process step, more easily and more uniformly in the alkaline solution). The suspended powder was stirred into 400 ml 0.1 N NaOH solution. The suspension was filtered out as quickly as possible.

A dark green filter cake and a yellow filtrate were obtained. The yellow filtrate was neutralised with 0.1 N HCl solution and adjusted to pH 6 for improved flocculation of the xanthohumol. The solid had to be filtered out again as quickly as possible. The filter cake obtained was washed out with water to remove the salts produced during neutralisation. The yellow/brown filter cake was then dried at 50° C. The dried filter cake had a xanthohumol content of 83% by weight. Of the xanthohumol in the green powder, 75% (relative) was recovered in the end product.

### Embodiment 2 (Small-Scale Production)

The experimental plant consisted of
two pumps,
a respective container for receiving the suspension of xanthohumol in ethanol or a suspension of diatomite (filtering auxiliary means) in 0.1 N sodium hydroxide solution,
a mixing section where the xanthohumol suspension was injected into the lye,
a mixer,
a precoat filter,
a receiving tank filled with 0.1 N hydrochloric acid and
a further filter (consisting of a Buchner funnel in the test).

Before the start of the addition, coarse, then fine diatomite was first pumped onto the precoat filter. In the test, 20 l of lye and 1.4 kg diatomite were used per kg of green powder.

1 kg of the markedly dark green powder was suspended in 1.6 l ethyl alcohol. This suspension was injected through a nozzle into a tube through which a further suspension of lye and diatomite was pumped. Xanthohumol was dissolved, other components such as, for example, chlorophyll remained undissolved. Immediately after the mixing zone there was installed a high-speed stirrer causing highly effective distribution. This mixture was pumped onto a precoat filter (lye and diatomite). Compressed air was applied to the filter container to accelerate filtration. The filtering process was repeated several times (pressure reduction, refilling, pressure build-up to filtering) until the suspension prepared had been filtered. The solution was neutralised immediately, whereupon there precipitated yellow xanthohumol. This solution was also filtered. The remaining xanthohumol was washed with water and then dried in a drying oven.

The xanthohumol content of the dried filter cake was between 75 and 85% by weight. Of the xanthohumol in the green powder, 72% (relative) was recovered in the end product. The increase in yield was a further aim, although this was said to be achieved using the conventional methods.

### GENERAL CONCLUSIONS

The suspension of the xanthohumol powder causes dissolution of resinous components and facilitates the formation of a uniform suspension. The type of solvent used is not important. The solvent must merely be non-toxic, on account of the risk of non-admitted residues, and must dissolve in water.

The residence time of the xanthohumol powder in the lye should be as short as possible, otherwise isoxanthohumol, which may be undesirable, forms. The residence time of the xanthohumol powder in the acid should also be as short as possible, otherwise derivatives and decomposition products of xanthohumol form.

What is claimed is:

1. A process for preparing a high-purity (60-90%) xanthohumol-containing powder from hops including the following process steps:
preparing a xanthohumol-enriched hop extract by extracting a xanthohumol-containing hop raw material using highly compressed CO₂ as a solvent at pressures above 500 bar and at temperatures above 60° C.,
suspending the xanthohumol-enriched hop extract in an alkaline solution for separation between by-products and xanthohumol, the xanthohumol preferentially being dissolved,
separating the undissolved by-products,
neutralisating and precipitating the dissolved xanthohumol with acid,
separating the precipitated xanthohumol concentrate from the acid, and
drying the separated concentrate.

2. A process according to claim 1, wherein before the xanthohumol-enriched hop extract is suspended in the alkaline solution, it is suspended in a solvent.

3. A process according to claim 2, wherein the solvent consists of an alcohol of low molecular weight.

4. A process according to claim 3, wherein the solvent is ethanol.

5. A process according to claim 1, wherein the alkaline solution for suspension is sodium hydroxide solution.

6. A process according to claim 1, wherein the acid is hydrochloric acid.

7. A process according to claim 1, wherein the dissolved xanthohumol is separated from the undissolved by-products in a precoat filter.

8. A process according to claim 7, wherein diatomite is used as a filter auxiliary means.

9. A process according to claim 1, wherein the xanthohumol reprecipitated by the addition of acid is separated from the still dissolved constituents by filtration.

10. A process according to claim 1, wherein the dried xanthohumol concentrate is crushed.

11. Use of a high-purity xanthohumol-containing powder prepared in accordance with any one of the preceding claims, wherein the hop extract is used as an admixture to solid, paste-like or liquid foods.
